(19) United States
(12) Patent Application Publication
(10) Pub. No.: US 2012/0259772 A1
(43) Pub. Date: Oct. 11, 2012

(54) Electronic money transfer embedded in social media communities

(76) Inventor: K. Patrick Lee, Carrollton, TX (US)

(21) Appl. No.: 13/506,287

(22) Filed: Apr. 9, 2012

Related U.S. Application Data
(60) Provisional application No. 61/472,859, filed on Apr. 7, 2011.

(51) Int. Cl. G06Q 20/10

(52) U.S. Cl. 705/39

(57) ABSTRACT

The systems and methods described include a method of electronically transferring funds from one person to another person. This system offers the option of using a social application for the process or of using solely the actual system called The Vault. The method of use includes at least one user to send the funds and at least one user to receive the funds. Each user establishes an account within a social application and or an account with the system called The Vault. The sender electronically sends a request for funds to be released to a receiving party, the funds are then verified and or cleared by the system called The Vault and then they are transferred to the receiving party.

### CROSS-REFERENCE TO RELATED APPLICATIONS

I am claiming the filing date of Provisional Application No. 61/472,859

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF TECHNOLOGY

Aspects of the disclosure relate to systems and methods of data processing. More specifically, the present invention relates to the financial aspect of data processing and systems and methods of a person-to-person electronic exchange of financial funds transfer.

### BACKGROUND OF THE INVENTION

The present invention is in the technical field of data processing. More particularly, the present invention is in the technical field of financial data processing.

Presently there exist conventional money transfer options such as postal services, wiring of money, express delivery, account debits, tendering cash, demand check, IOUs, drafts. These methods are typically expensive, risky and cumbersome to prepare, transfer, handle, locate and exchange. Currently, individual consumers are able to electronically submit payments to business creditors through a variety of electronic means. The benefits of reduced costs, convenience, ease of use and reduced risk to settle monetary balances are drawing more and more customers to use electronic fund transfers.

The movement of funds between individuals is currently achieved through the following steps: the parties agree on amounts and the method of exchange; the parties prepare the funds based on the decided method of exchange; the parties acquire and execute the tender; the parties send the funds; receive the funds; and lastly the parties take steps to deposit, clear or convert the received funds to cash. Having to take so many steps is difficult, costly and time consuming. Excess fees can be added on to each portion of the transaction. During the actual transportation of cash, it is vulnerable to being lost, destroyed or exploited. Transporting funds person-to-person frequently leaves little or no documented evidence of the completed transaction. For the above stated reasons, there is often a failure of the cycle to be completed and there are often disputes that result amongst the involved parties.

Because of the physical nature and the tangible dimension of actual cash, moving it can be both challenging and difficult. Often times, physical cash is lost and there is no way of replacing it once lost. Moreover, the highest risk involved in the transferring of cash is in the actual transportation of the cash itself to the place where it will be transferred.

It would be ideal to allow socially related persons to send and receive money to and from each other with the benefit and convenience of a type of an electronic fund transfer. Therefore, improvements in the art of person-to-person monetary transfers are needed.

### BRIEF SUMMARY OF THE INVENTION

The systems and methods described include a method of electronically transferring funds from one person to another person with the option of using a social application, and the actual system used to transfer the funds. The method of use includes at least one user that is sending the funds and at least one user that will receive the funds. Users include but are not limited to individuals, groups, companies, corporations, entities, banks, firms, the federal government or individual states. For the social application method, each user establishes an account within a social application, for example Facebook. Further, each user establishes an account with the present invention, which is a system and its method of use which is hereon in called The Vault. For use without the social application an account need be established with only The Vault. The minimum information required for The Vault is the name of the party, a Vault user ID, the Party's bank account number, party's bank ABA/routing number, the type of account-checking or savings, the party's email address and the ACH transaction code to use by default for this party. The accounts on the chosen social application and or The Vault established by the users will contain but not be limited to, particular user account information, profile data, and an identified network of associates, friends and family. The method further includes logging onto the chosen social application, then logging onto The Vault and electronically sending a request for funds to be released from the sending party. The method further includes the funds being verified and or cleared by The Vault, the system preparing the outgoing send transaction, and the receiving party's electronically receipt of the funds. Further, one method of use is based on the use of a social application in which all parties must have an account with and must log onto in order to utilize The Vault to transfer funds on a person-to-person basis.

The system described is initiated by logging onto a social application including but not limited to Facebook and then further logging onto the The Vault system. The system can be viewed in any language. The user then requests that the system send funds to another specified user of The Vault. The Vault will then collect the necessary data required to initiate a money transfer and the necessary data for the subsequent process to transfer outgoing funds to the intended recipient. Further, the system called The Vault will then access independent resources for the clearing and settlement of the debit, credit, checking or other process within The Vault. The result of the functioning system called The Vault is that its user is able to send funds to another Vault user utilizing only a social application and the system called The Vault.

Another embodiment includes a method of utilizing The Vault on a separate and independent website besides a social application. The system described is initiated by logging onto a website that includes The Vault system and then further logging onto The Vault. The user then requests that the system send funds to another specified user of The Vault. The Vault will then collect the necessary data required to initiate a money transfer and the necessary data for the subsequent process to transfer outgoing funds to the intended recipient. Further, the system called The Vault will then access independent resources for the clearing and settlement of the debit, credit, checking or other process within The Vault. The result of the functioning system called The Vault is that it's user is able to send funds to another Vault user utilizing only the applicable website and the system called The Vault.

Another embodiment includes a method of utilizing The Vault for funds exchanged of varying currencies. The system described is initiated by logging onto a social application including but not limited to Facebook and or then logging onto the The Vault. Without the use of a social application, the users need only log onto The Vault. The user then requests that the system send funds to another specified user of The Vault and further specifies the type of currency the recipient requires. The Vault will then collect the necessary data required to initiate a money transfer, the necessary data to convert the currency and the necessary data for the subsequent process to transfer outgoing funds to the intended recipient. Further, the system called The Vault will then access independent resources for the clearing and settlement of the debit, credit checking or other process within The Vault. The result of the functioning system called The Vault is that its user is able to send funds to another Vault user utilizing only a social application and or the system called The Vault.

### BRIEF DESCRIPTION OF THE DRAWINGS

Reference to the remaining portions of the drawings and specifications shall provide a further understanding of the advantages and the workings of the present invention. The drawings are process blocks that function as flow diagrams. Each step or function is labeled with a numerical value, which is discussed in detail below in the detailed description of the drawings.

FIG. 1 is a process block flow diagram that illustrates the overall deployment of The Vault;

FIG. 2 is a process block flow diagram that further illustrates the user flow in more detail;

FIG. 3 is a process block flow diagram that illustrates how The Vault processes the applicable information; and

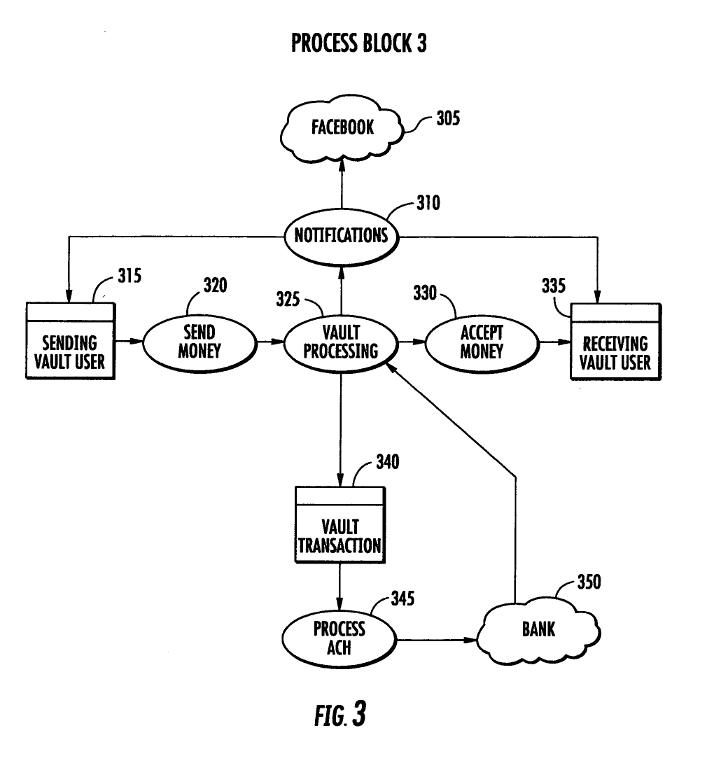

FIG. 4 is a process block flow diagram that illustrates an overview of The Vault's processing.

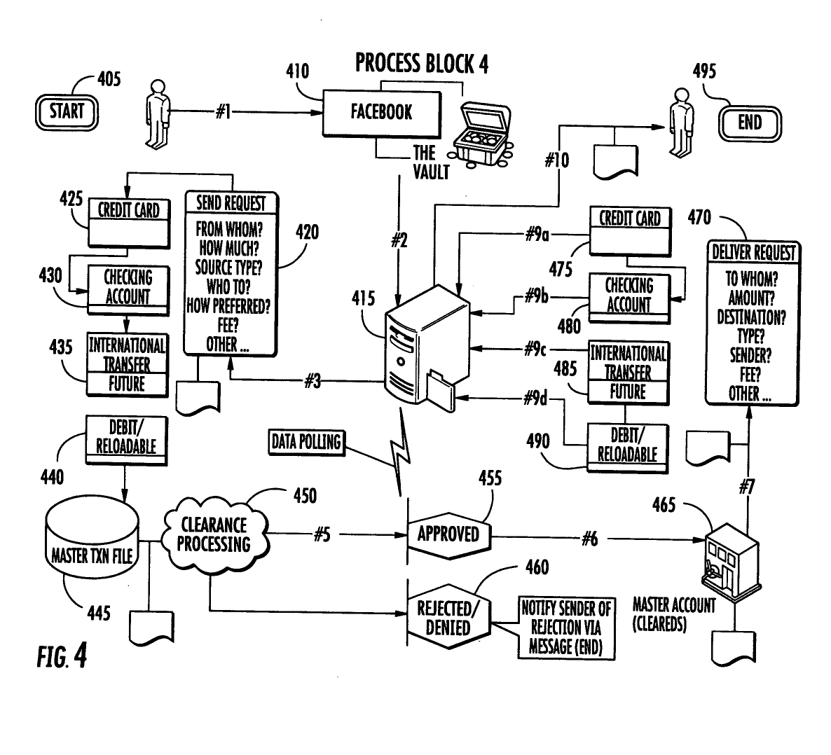

### DETAILED DESCRIPTION OF THE DRAWINGS

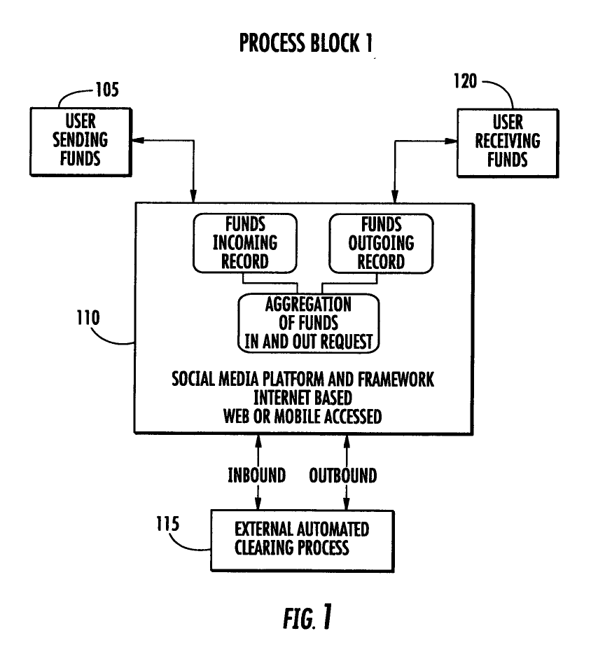

FIG. 1, Process Block 1 depicts an overall deployment of The Vault system. Block 105 shows how a user initiates the process. This user intends to send funds to a recipient. Block 110 is an overall picture of what happens once the process is initiated by a user. The process can occur within the social media platform and framework, on the internet on The Vault's website or through the use of a mobile device. Inside Block 110 a record of the incoming funds is produced and it is then passed onto the aggregation of a funds in and out request. The record is then sent to an external automated clearing process, Block 115, which, upon clearance will be sent back into Block 110 where a record of the outgoing funds is produced. Lastly, the record is sent to Block 120 where the user receives the funds.

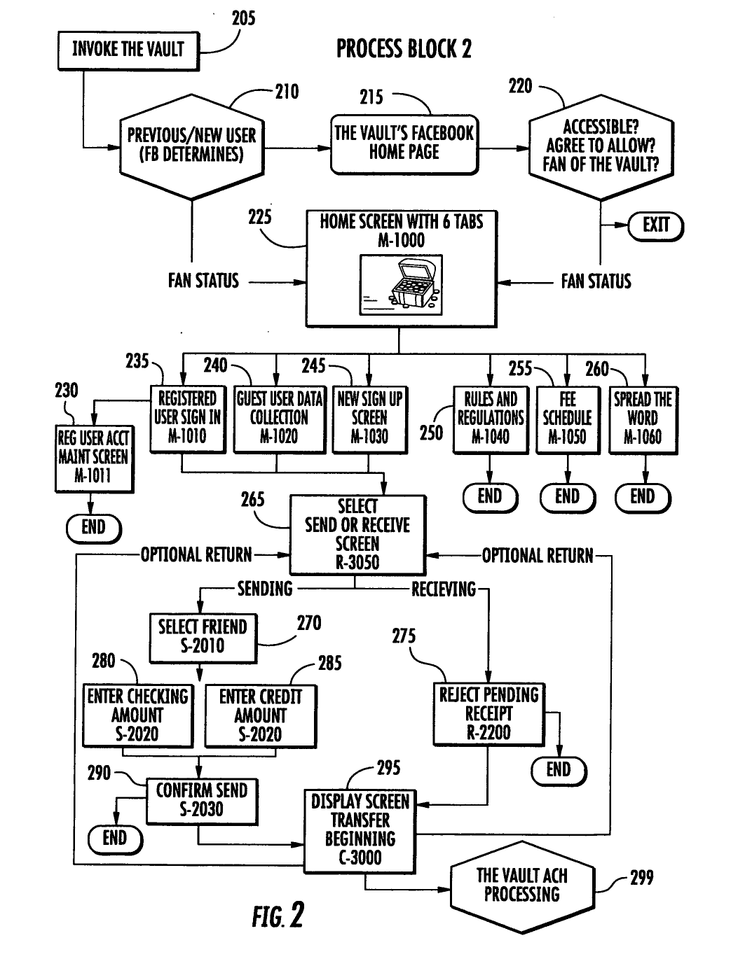

FIG. 2, Process Block 2, presents a more detailed view of both the method of use and the system called The Vault. This process block is an example of use within the social application called Facebook. Block 205 is where the user invokes The Vault by logging onto The Vaults homepage. Block 210 is where the social application determines whether or not this is a previous user or a new user. Block 215 is where a new user is directed to The Vault's homepage. Block 220 is where the user is required to answer such prompts such as whether there is accessibility, whether he agrees to allow the application; and or whether he is a fan of The Vault. The user can chose to exit the home page at this point. If the user has chosen fan status he is prompted to Block 225, which is The Vault's home screen. If the Previous User elects fan status, he is also sent to Block 225.

On the home screen, there are 6 different tabs that have been labeled as blocks. Block 235 is where a registered user can sign in. Block 240 is where a guest user can submit his data. Block 245 is where a new user can sign up for The Vault. Block 250 is the tab where the rules and regulations are listed. Block 255 is the current fee schedule. Block 260 is the tab that is called “Spread the Word” where you can tell others about The Vault application.

Once the information required by Blocks 235, 240 or 245 are complete, The Vault prompts another screen, Block 265 that will allow the user to send or receive funds. Once the information for Block 235 has been completed, The Vault will prompt a screen with the option for the registered user to maintain his account.

From Block 265 the user can either send or receive funds. If the user decides to send funds, he is directed to Block 270 where he will select a friend to send the funds to. Upon selecting a friend, he will either chose Block 280 for payment by checking account or Block 285 for payment by credit. He will also have the option to chose to make partial payments by both if he wishes. In Blocks 280 and 285, he will chose the amount he wishes to send. In Block 290, he will confirm the send in process. The process can end at this point for the sending user, however Block 295 shows that there will also be a display screen showing that the transfer is beginning. From here, the send command goes out to Block 299 which is The Vault's Automated Clearing House (ACH) processing. This is a method of dispersing funds through an electronic method. The ACH process application provides an automated, secure, easy-to-use solution to create and transmit ACH files in any NACHA format. The ACH application is installed at the users location, not an internet site, and therefore can be fully integrated and automated with the existing system. Once cleared the sending user is given an optional return screen to Block 265.

The recipient user logs on in the same manner as listed above with the exception of when he arrives to Block 265 he will chose the receive option on the screen. Here he can receive the funds as they have been sent and confirmed by the user sender. The recipient user has the option in Block 275 to reject the pending receipt. This is the end of the process as depicted in Process Block 2.

Process Block 3 depicts how The Vault processes the applicable information. Block 305 is where the user is logged onto Facebook, which is an example of an optional social application that may be used for access to The Vault. Notifications are sent to Facebook from The Vault as shown in Block 310. The notifications are sent from The Vault Processing center as shown in Block 325. The notifications are sent to both the sending user as shown in Block 315 and the recipient user as shown in Block 335. The sending Vault user sends the money as shown in Block 320. The send command then goes to The Vault's Processing center as shown in Block 325. The Vault's processing center the initiates a Vault Transaction as shown in Block 340, which then is sent to a process ACH as shown in Block 345. Once cleared, notification is sent to the appropriate back as shown in Block 350 and then back to The Vault Processing Center. The Vault processing center then sends a notification for the recipient to accept the money as shown in Block 330. The Vault user can then accept the funds as depicted in Block 335.

Process Block 4 is another depiction of the funds transfer process of The Vault. The process begins with Block 405 where the user logs onto Facebook, which is Block 410, and then onto The Vault. From there the user logs onto their account, creates an account or signs in as a guest, which is shown in Block 415. In Block 420 the user has chosen to send a request for funds to be dispersed. The send request requires answers such as: From whom are the funds coming? How much is to be sent? What is the source you chose to take the funds from? Who do you want to send the funds to? How do you prefer to send the funds? Is there a fee involved? Which language do you chose to view? What currency do you wish to send? The applicable information is then sent to the credit card Block 425, the checking account Block 430, the international transfer/future transfer Block 435 or the Debit account, Block 440. From this point the appropriate information is sent to the master TXN file as shown in Block 445, which collects and prepares the information regarding the transfer and then processes the request and sends it to clearance processing as shown in Block 450. The request is either approved as in Block 455 or denied as in Block 460. If there has been a rejection or a denial there is a notification to the sender of the rejection through a message as shown in after Block 460. If there has been an approval, the message is sent to the Master Account, which settles the moving funds and is a temporary holding place where the funds are held until the funds have been fully cleared by the ACH process. Once cleared a deliver request is sent as shown in Block 470. The request takes into account questions such as to whom the funds are being sent, the amount that is being sent, the destination the funds will reach, the type of instrument being used, who the sender is, and if there are any other applicable fees. There may be other questions that are not listed here. The delivery of the funds is then made to the chosen instrument or instruments as shown in Blocks 475, 480, 485 and or 490. Lastly a message is sent to the recipient that funds have been sent, as shown in Block 495.

### DETAILED DESCRIPTION OF THE INVENTION

The present invention is a method of transferring funds from person-to-person, in which users may include but are not limited to individuals, groups, companies, corporations, entities, banks, firms, the federal government or individual states. The present invention is also the system that is used to transfer the funds from person-to-person.

The method of use with a social application is comprised of the following steps: the sender establishing an account with the social application, for example Facebook; the sender establishing an account with The Vault system that is within the social application; the minimum information required for The Vault is the name of the party, a Vault user ID, the Party's bank account number, party's bank ABA/routing number, the type of account-checking or savings, the party's email address and the ACH transaction code to use by default for this party the sender signing in to his Vault account; the sender selecting the send option on the select send or receive screen; the sender then selecting a receiver who will receive the funds; the sender selecting the type of instrument which will be used to send the funds including but not limited to checking accounts, debits, credit cards, gift cards, and vouchers; the sender selecting the amount he wants to send; the sender confirming the instrument type used and the amount he has chosen to send; the information being transferred to The Vault ACH Processing center; The Vault system preparing the outgoing send transaction; the funds being verified or cleared by The Vault system; the information being returned to the receiver's select send or receive screen; the recipient establishing an account with the social application, for example Facebook; the recipient establishing an account with The Vault system that is within the social application; the recipient signing in to his Vault account; the recipient selecting the receive option on the select send or receive screen; the recipient receiving the funds. The ACH process application provides an automated, secure, easy-to-use solution to create and transmit ACH files in any NACHA format. The ACH application is installed at the users location, not an interne site, and therefore can be fully integrated and automated with the existing system. The method of use of The Vault without a social application is the same as above with the exception that the user should go directly to The Vault's website to log into The Vault's system.

The method of transferring funds person-to-person is further comprised of an option to choose the language The Vault will be viewed in, to choose the type of currency to be transferred, to send or retrieve funds, and or to lock in an exchange rate for senders and recipients.

The system called The Vault functions by the user logging onto the chosen social application and then logging onto The Vault's home page on the social application, thereby invoking The Vault. The Vault system then prompts questions as to whether the user wishes to allow The Vault application to run. The Vault system then prompts a user terms and agreement form that, if accepted by the user prompts the next screen. The Vault system then prompts either a registered user's sign in page, a guest user's data collection page, a new user sign up screen, a rules and regulations screen, a fee schedule screen or a spread the word screen depending on the user's choice. The Vault system will then present to the registered user the option to maintain their account. The Vault will then provide to guest users, registered users and new users the option of sending or receiving funds

The Vault system will then prompt a series of questions if the user decides to send funds. The questions are comprised of but are not limited to: To whom are the funds being sent? How much is the user sending? What is the source for the funds that the user chooses? How does the user prefer the recipient to receive the funds? The Vault system will also list any fees involved with the transaction.

The Vault system will then send requests to the chosen source of funds based on the answers to the above listed questions. The Vault will then send the information to the Master TXN File, which collects and prepares information regarding the transfer.

The Vault also will defer to a clearance process which can be any one of various commercially available protocols, standards, networks and regulatory requirements including but not limited to Automated clearing house, SWIFT, EFTS, Electronic Data Interchange (EDI), EMT, Wire Transfer, Electronic Funds Transfer (EFT), Giro, STAR, Pulse, NYCE and others.

Lastly, The Vault system will either approve, reject or deny the transaction based on the outcome of the clearance process. The Vault system will then notify the sender through a message if the transaction has been denied or rejected. The Vault's master account will receive the approval message and send a deliver request if the transaction has been approved.

The Vault system will then prompt questions for the delivery request, including but not limited to: To whom are the funds being sent? What is the amount being sent? What is the destination of the funds? What is the type of instrument being used to collect the funds? Who is the sender? What are the fees involved in the transaction?

The Vault will then message and or email the recipient that funds are coming and or that the funds have been sent. The Vault will email the sender confirming transfer and or email the recipient asking for confirmation. The Vault will email a confirmation and or may warn that the funds are not being processed or that the send was rejected. The Vault will message and or email a confirmation of the transaction and or message and or email a thank-you to the users.

The Vault will send the funds to the designated recipient, in the designated amount, and to the designated instrument once questions above have been answered. The Vault will prompt a message informing the recipient that funds have been transferred to him if the transaction is approved and the recipient has logged onto both the social application and The Vault's homepage.

Further, The Vault will have it's own website so that it can be accessed either through The Vault website or the social application. The Vault can be accessed through a downloadable application on a Smartphone, a tablet or any other electronic device. The Vault can also be accessed at MAC and or Debit machines. There will also be an option to schedule and execute recurring transfers to designated recipients on The Vault system. The Vault will also offer the sender the option of stopping a transfer before the recipient accesses it. The Vault will also offer to the sender an option of expediting transfers. The Vault will also offer an option of making a charitable donation before, during or after the transaction to both the sender and the recipient. The Vault will allow the recipient to deduct funds from the transfer to make a charitable donation. The Vault offers the option of using multiple source instruments for the same or different amounts, to send funds to the recipient. Instruments include but are not limited to credit cards, debit cards, a combination of account types, a Vault card, savings accounts and or physical checks. The Vault is an international website that can be viewed in multiple languages and that will offer currency conversion. The Vault will also offer transactions to be made from multiple currencies to multiple currencies, meaning one type of currency can be sent and a different type of currency can be received. The Vault system can also use multiple source instruments for the same or different amount, to send or to receive the funds. The Vault also offers the option to send a greeting, message or picture along with the funds. The Vault also offers an option to deposit funds in a savings account. The Vault also offers the option for either the sender or the recipient to pay all of the associated fees. The Vault also offers the option for the sender to remain anonymous. The Vault also offers the option for the receiver to issue a refund of funds.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A method of transferring funds from person-to-person, in which users may include but are not limited to individuals, groups, companies, corporations, entities, banks, firms, the federal government or individual states. The method comprising:
the sender and recipient establishing an account with the social application, for example Facebook;
the sender and recipient establishing an account with The Vault system that is within the social application; the sender and recipient entering the following information at a minimum that is required for The Vault account: the name of the party, a Vault user ID, the Party's bank account number, party's bank ABA/routing number, the type of account-checking or savings, the party's email address and the ACH transaction code to use by default for this party;
the sender signing in to his Vault account;
the sender selecting the send option on the select send or receive screen;
the sender then selecting a receiver who will receive the funds;
the sender selecting the type of instrument which will be used to send the funds including but not limited to checking accounts, debits, credit cards, gift cards, and vouchers;
the sender selecting the amount he wants to send;
the sender confirming the instrument type used and the amount he has chosen to send;
the information being transferred to The Vault ACH Processing center;
The Vault system preparing the outgoing send transaction;
the funds being verified or cleared by The Vault system;
the information being returned to the receiver's select send or receive screen;
the recipient establishing an account with the social application, for example Facebook;
the recipient establishing an account with The Vault system that is within the social application;
the recipient signing in to his Vault account;
the recipient selecting the receive option on the select send or receive screen;
the recipient receiving the funds.

2. A method of transferring funds person-to-person as in claim 1, further comprising an option to choose the language The Vault will be viewed in.

3. A method of transferring funds person-to-person as in claim 2, further comprising an option to choose the type of currency to be transferred.

4. A method of transferring funds person-to-person as in claim 3, further comprising multiple options to send or retrieve funds.

5. A method of transferring funds person-to-person as in claim 4, further comprising locking an exchange rate for senders and recipients.

6. A system called The Vault that functions by:
The user logging onto the chosen social application and then logging onto The Vault's home page on the social application and thereby invoking The Vault;
The Vault prompting questions as to whether the user wishes to allow The Vault application to run;
The Vault prompting a user terms and agreement form that, if accepted by the user prompts the next screen;
The Vault prompting either a registered user's sign in page, a guest user's data collection page, a new user sign up screen, a rules and regulations screen, a fee schedule screen or a spread the word screen depending on the user's choice;
The Vault will present to the registered user the option to maintain their account;
The Vault will providing to guest users, registered users and new users the option of sending or receiving funds;
The Vault then prompting a series of questions if the user decides to send funds. The questions comprising but not being limited to: To whom are the funds being sent? How much is the user sending? What is the source for the funds that the user chooses? How does the user prefer the recipient to receive the funds? The Vault will also list any fees involved with the transaction. The Vault offers transactions to be made from multiple currencies to multiple currencies. The Vault also is able to use multiple source instruments for the same or different amount, to send or to receive the funds.
The Vault sending the requests to the chosen source of funds based on the answers to the above listed questions;
The Vault sending the information to the Master TXN File, which collects and prepares information regarding the transfer;
The Vault using a clearance process which can be any one of various commercially available protocols, standards, networks and regulatory requirements including but not limited to Automated clearing house, SWIFT, EFTS, Electronic Data Interchange (EDI), EMT, Wire Transfer, Electronic Funds Transfer (EFT), Giro, STAR, Pulse, NYCE and others;
The Vault either approving, rejecting, or denying the transaction based on the outcome of the clearance;
The Vault notifying the sender through a message if the transaction has been denied or rejected;
The Vault's master account receiving the message and sending a deliver request if the transaction has been approved;
The Vault prompting questions for the delivery request, including but not limited to: To whom are the funds being sent? What is the amount being sent? What is the destination of the funds? What is the type of instrument being used to collect the funds? Who is the sender? What are the fees involved in the transaction?
The Vault sending the funds to the designated recipient, in the designated amount, and to the designated instrument once questions above have been answered;
The Vault messaging and or emailing the recipient that funds are coming and or that the funds have been sent. The Vault emailing the sender confirming transfer and or email the recipient asking for confirmation. The Vault emailing a confirmation and or warning that the funds are not being processed or that the send was rejected. The Vault messaging and or emailing a confirmation of the transaction and or message and or email a thank-you to the users.

7. A system as in claim 6, further comprising access through The Vault's website or the social application.

8. A system as in claim 7, further comprising access through a downloadable application on a Smartphone, a tablet or any other electronic device.

9. A system as in claim 8, further comprising access to The Vault at MAC and or Debit machines.

10. A system as in claim 9, further comprising an option of scheduling and executing recurring transfers to designated recipients.

11. A system as in claim 10, further comprising an option of the sender stopping a transfer before it is accessed by the recipient.

12. A system as in claim 11, further comprising an option of expediting a transfer by the sender.

13. A system as in claim 12, further comprising an option of making a charitable donation before, during or after the transaction by either the sender or the recipient. The recipient will be able to deduct funds from the transfer to make a charitable donation.

14. A system as in claim 13, further comprising an option of using multiple source instruments for the same or different amounts, to send fund to the recipient.

15. A system as in claim 14, further comprising an option of using multiple source instruments for the same or different amount, to send or to receive funds.

16. A system as in claim 15, further comprising an option to send a greeting, message or picture along with the funds.

17. A system as in claim 16, further comprising an option to deposit funds in a savings account.

18. A system as in claim 17, further comprising an option for the sender or the recipient to pay all applicable fees.

19. A system as in claim 18, further comprising an option for the sender to remain anonymous.

20. A system as in claim 19, further comprising an option for the receiver to issue a refund of funds.
